(19) United States
(12) Patent Application Publication
(10) Pub. No.: US 2003/0095901 A1
(43) Pub. Date: May 22, 2003

(54) Arrangement for mounting a screen

(76) Inventor: Antti Isola, Pietarsaari (FI)

Correspondence Address: YOUNG & THOMPSON, 745 SOUTH 23RD STREET 2ND FLOOR, ARLINGTON, VA, 22202

(21) Appl. No.: 10/287,696

(22) Filed: Nov. 5, 2002

(30) Foreign Application Priority Data
Nov. 6, 2001 (FI) 20012144

(51) Int. Cl. B01J 8/00

(52) U.S. Cl. 422/217; 422/187

(57) ABSTRACT

An arrangement for mounting a screen (20) in a continuous digester used for making chemical pulp or paper pulp. Such a digester includes a substantially cylindrical pressure vessel arranged in an upright position, the pressure vessel having a smaller diameter at the top end of the digester than at the bottom end of the digester, the diameter of the digester being changed at regionally defined areas by one or more conical sections (4). The screens are mounted at these conical sections to remove liquid from chips or pulp in the digester. In the present arrangement an upper edge (21) of the screen (20), which, in the operating position, is located higher, is arranged in the region of the conical section (4). In particular, the screen extends substantially to the section of the conical section, which has the smallest diameter.

### FIELD OF THE INVENTION

The present invention relates to an arrangement according to the preamble of claim 1.

This type of arrangement involves particularly the arranging of a bar screen in a continuous pulp reactor, which is known as a Kamyr reactor. Such an arrangement can be utilized in reactors in use, the operation of which post-mounted new screens will improve, and in new continuous reactors. The purpose of a screen to be mounted is, in particular, the efficient removal of cooking and circulation liquid from a vessel of a reactor when chemical pulp or paper pulp is made with a continuous reactor.

### BACKGROUND OF THE INVENTION

Today, continuous digesters for instance comprise substantially cylindrical pressure vessels arranged in an upright position. Pressure vessels of continuous pulp digesters are remarkably high, and their diameter can be several meters. For instance, the diameter of the bottom part of a pressure vessel may be 4000 mm to 10000 mm, typically about 6000 mm.

The diameter of the cover of such a pressure vessel is usually smaller at the top end of the digester than at its bottom end. However, the diameter of the digester does not increase conically along the entire length of the digester, but is arranged to increase at regionally defined areas by means of one or more conical sections. The exact positions of the conical sections are defined by process-specific technical grounds. To remove cooking and circulation liquid processed in the digester, the digester comprises screens, which are usually mounted below the above-mentioned conical sections. In such a case, the distance between the upper edge of the screen and the lower edge of the conical section is selected so as to vary from a few hundred millimeters to several meters.

The cover of a pressure vessel of a pulp digester is usually made of metal plates, the thickness of which may vary from 20 mm to 50 mm, the width from 1000 mm to 3000 mm and the length from 4000 mm up to 6000 mm. In the first manufacturing stage of a digester, metal plates are welded together so as to form cover blanks, which correspond to the circumference of the pressure vessel. Next these cover blanks are bent into cylindrical pieces of the cover, which are welded together with a round joint in order to form a cover for the cylindrical pressure vessel of the digester. The conical sections at the cover of the pressure vessel are also made by bending a long blank into a cone and by welding the conical sections to the rest of the cover of the pressure vessel with a round joint.

Due to the considerable size of a pressure vessel, deviations from theoretical shapes of a cylinder and a cone, produced during the manufacture of the pressure vessel, are significant. So, the cross-sectional profile of a finished digester often differs from the planned theoretical circular cross-section considerably and is, in fact, more like elliptical. In addition, the vertical joint of the pressure vessel, i.e. the joint which combines the ends of the cover blank forming the pressure vessel, may be markedly discontinuous. At this vertical joint, due to welding stress, the shape usually differs from an elliptical curve and is more like angular.

These deviations from the intended circular cross-section, which are due to the manufacturing method of a digester's pressure vessel, cause many problems. One problem arises, for instance, when the inner surface of the pressure vessel is provided with the screens required.

Conventionally, this type of screens are mounted, for instance, in the washing cycle of a continuous digester, i.e. at the lower end of a pressure vessel forming the digester, so that the region of a cone which increases the diameter of the digester of the pressure vessel is provided with a solid annular metal plate—a kind of a trailing edge—allowing a cooking flow of chips to pass untroubled from the top of the digester to the bottom of the digester where it is subjected to the influence of the screens. An upper back-up ring arranged substantially horizontally on the inner surface of the pressure vessel is supported underneath the cone which increases the diameter, the ring being arranged to support both the upper edge of the screens to be mounted in the pressure vessel and the annular metal plate onto the cover of the pressure vessel.

Correspondingly, a lower back-up ring is conventionally supported onto the inner surface of the pressure vessel substantially horizontally so that it supports the lower edge of the screens onto the cover of the pressure vessel. A number of vertical supports required by the screens are fixed conventionally between these upper and lower back-up rings. The edges of the screens are attached to a “grid” being formed by the support structures, which grid is also called a screen bed.

In this kind of construction, forces directed to the surface of screens are usually arranged to be transmitted to the cover of the pressure vessel by means of support rods, i.e. bars of specific length fixed to transverse supports arranged between the upper back-up ring and lower back-up ring of the screen. If the screen gaps of the screen construction are made by cutting them in what is known as a screen plate, the support rods are preferably fixed directly to the screen plate to provide support.

The fixed size of support rods and asymmetry of a pressure cover of the digester's pressure vessel tend to cause problems, however. Due to the deviations of the shape of the pressure cover, a considerable number of support rods are not supported onto the pressure cover, but at their one end, the support rods are hanging freely in the background space of the screen, which is formed between the screen and the pressure cover. Since the support rods are not supported onto the cover of the digester, theoretical strength calculations of the screen structure are no longer reliable. The object of transmitting forces directed to the screen construction to the pressure cover of the digester is thus not achieved by using support rods. Because of the disadvantageous force stress the support rods bend and the screen twists, even breaks.

In conventional solutions, in which screens are mounted underneath the conical section of the digester, the space behind the screens and a “header”, i.e. a collector tray in connection with it and leading to an outlet fitting of the digester, is full of liquid which flows through the screens. In these solutions the volume of each space is relatively large and thus the flow rate of the liquid is low. A disadvantage of this known construction is that deposits are easily formed in the spaces behind the screens. To remove these deposits, for instance, the operation of the digester must be stopped every now and then, which causes a shutdown of the factory, which is a time-consuming and expensive procedure.

On economic grounds, pulp manufacture often employs existing digesters which are used to produce much more than their rated capacity would allow. This makes the significant problems related to the use of the inner space of the digester even clearer. So the conventional ways of mounting screens do not secure the operation of the digester with the present production objectives, but the blockage of the screen harms the operation of the digester considerably. The blockage makes the filtering capacity of screens considerably weaker and reduces the volumes of the liquids to be circulated notably, thus weakening the production and productivity of the digester.

### BRIEF DESCRIPTION OF THE INVENTION

It is an object of the present invention to prevent the problems caused by prior art disadvantages as efficiently as possible and thus to provide a new solution, where a screen construction in a digester can be maximized and the commercial objectives set to digesters can be achieved better than before.

This object is achieved by an arrangement having the characteristics defined in the claims of the invention. The present problems can be solved, in particular, by combining the characteristics in the manner disclosed in the characterizing part of claim 1.

The preferred embodiments of the invention are set forth in the dependent claims.

The terms “up”, “down”, “above”, “underneath” etc. used in the description illustrate the features of the invention in directions which are in relation to the arrangement of the invention in a way shown in the attached figures.

The invention provides considerable advantages. By using the present system, it is much easier to mount screens in a pressure vessel than by using known solutions. Also, screens are supported much more reliably than before, whereupon the force stress directed to the screens is distributed to the cover of the pressure vessel according to the strength calculations. The present arrangement also allows screens with a larger area to be mounted in a digester, which improves the productivity of the digester.

The present invention also increases the flow behind the screen, which makes the operation of the digester more effective and prevents the deposition in the background space of the screens.

To remove deposits from the background spaces of screens is usually very laborious and expensive during annual shutdowns. Due to the present invention, service and shutdown intervals can be made much longer, which brings considerable savings in working costs, for instance.

### BRIEF DESCRIPTION OF THE FIGURES

In the following a preferred embodiment of the invention will be described with reference to the attached drawing, in which

FIG. 1 shows the bottom of a digester partly in section, where the part on the right of the vertical axis of the digester schematically illustrates the conventional fixing arrangement of a screen and the part on the left of the vertical axis schematically illustrates the arrangement of the invention for mounting a screen,

FIG. 2 is a schematic, vertical section of the upper end of the screen, the screen being mounted with the arrangement of the invention,

FIG. 3 is a schematic, vertical section of the lower end of the screen, the screen being mounted with the arrangement of the invention,

FIG. 4 shows a structural detail of the point det. A of FIG. 3.

### DETAILED DESCRIPTION OF THE PREFERRED EMBODIMENT

In the following, preferred embodiments of the present arrangement are described with reference to the above-mentioned figures. The arrangement comprises structural parts marked with reference numbers in the figures and corresponding to the reference numbers used in this description.

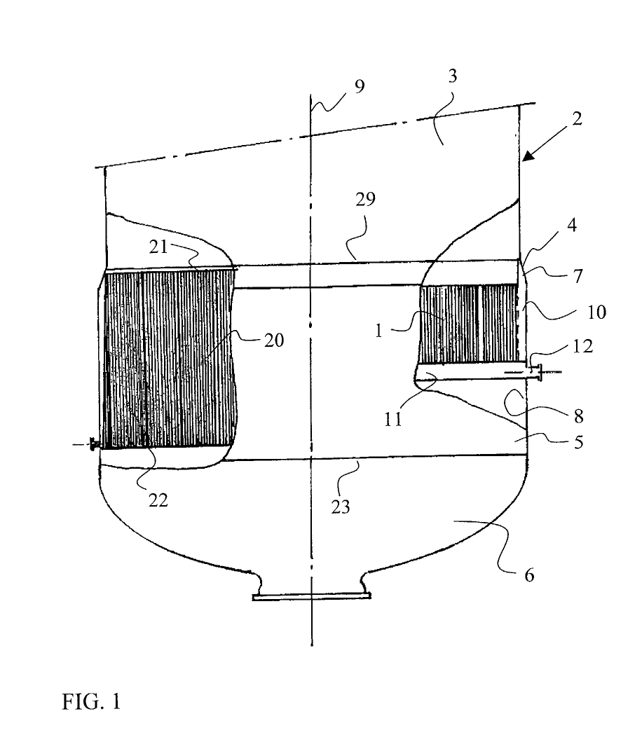

With reference to FIG. 1, particularly to its part on the right-hand side, a conventionally known fixing arrangement of screens 1 of a continuous pulp digester can be described as follows. The figures show a pressure cover 2 of the digester, comprising a second lowest, cylindrical cover section 3, a lowest conical section 4, a lowest cover section 5 and a bottom end 6. To extend the smaller-diameter cover section 3 of the pressure cover, the region of the conical section is provided with a solid metal ring plate 7 with a substantially corresponding diameter. The ring plate is thus arranged to guide a cooking flow of chips from the top of the digester to a region where it is subjected to the influence of the screen 1 serving as an extension for the ring plate. A substantially horizontal upper back-up ring is arranged underneath the conical section in a known manner, the ring supporting the upper edge of the screen and the lower edge of the ring plate onto the inner surface 8 of the pressure cover of the digester. Correspondingly, a lower back-up ring is arranged horizontally on the inner surface of the digester to support the screen at its lower edge. A number of vertical supports required by the screens are arranged between these parallel support rings, whereby the support rings and the vertical supports form a grid-like screen bed. The outer edges of the screens are attached to this screen bed.

The screens 1 comprise a number of parallel screen bars, which form a screen surface which faces towards the central axis 9 of the digester. This screen surface is subjected to force effects of chip flow moving in the digester, which force is arranged to be transmitted to the pressure cover 2 of the digester by means of support rods, i.e. round bars of specific length fixed to the transverse supports.

A flow space 10 is formed between the screens 1 mounted on the screen bed and the inner surface 8 of the pressure cover, and by means of a collector tray 11, the flow space is in connection with an outlet fitting 12 which leads liquid out of the digester.

The left part of FIG. 1 and FIGS. 2 to 4 show another specific embodiment with a fully new structure, in which screens 20 are arranged in a continuous pulp digester.

Since a significant problem of a conventional screen 20 is too low a filtering capacity in relation to the filtering area, this is solved by extending at least one end—the upper edge 21—of a screen in a completely new manner to the top end of the conical section 4 which increases the diameter of the pressure vessel forming the digester. The opposite end—the lower edge 22—of the screen is arranged to extend towards the bottom end 6 of the digester, thus extending, within the limits defined by its construction, as low as possible.

A preferable mounting of the screen 20 may be at the lowermost part of the digester, whereby the screen is arranged to extend from the top end of the substantially last conical section 4 to substantially close to a round joint 23 combining the lowermost, cylindrical cover section 5 of the pressure vessel and the bottom end 6 forming the pressure vessel.

This kind of arrangement for mounting screens 20 at least partly on the region of the conical section 4 comprises a separate screen bed for each individual screen. The screens are thus arranged to be supported by support rods 24 which are supported onto the inner surface 8 of the pressure vessel and the length of which can be adjusted. As the length of the support rods can be adjusted, shape deviations of the pressure cover 2, otherwise typical for digesters, can be compensated efficiently. When the support rods are mounted, they are adjusted to extend along the entire length from a frame structure of the screen to the inner surface 8 of the pressure vessel. Thus, all support rods of the upper transverse support 25 supporting the upper edge 21 of the screen are supported against the inner surface of the pressure vessel. The lower transverse support 26 supporting the lower edge 22 of the screen in the corresponding manner and at least one intermediate transverse support (not shown) therebetween comprise support rods, which can be supported against the inner surface of the pressure vessel by a simple adjustment. When the support structure for the screens is supported in this way, the allowable load of the screen is not exceeded and the screen bars, which are forming the functional part of the screen being on the screen surface 27 on the side of the central axis of the digester, remain in their places and fulfill their purpose when filtering the digester liquid.

The height and spread angle of the conical section 4 which increases the diameter of the pressure vessel are used to define a height for such a sheet metal ring 28 that is, if required, arranged to guide a cooking flow of chips from the smaller-diameter region of the digester to the region where it is subjected to the influence of the screen 20. In extreme cases, i.e. when the upper transverse support supporting the screen's upper edge 21 which, in its operating position, is higher in the digester, is arranged substantially in connection with the joint combining the conical section with the cover section of the pressure vessel above the conical section, no sheet metal ring is required. In an exemplified embodiment according to the figures, the upper transverse support 25 of the screen 20 is arranged at the joint 29 above the conical section 4 and combining the pressure vessel with the cover section 3. Usually the height of such a sheet metal ring is 50 mm to 500 mm. Most preferably, the height of the ring is about 200 mm.

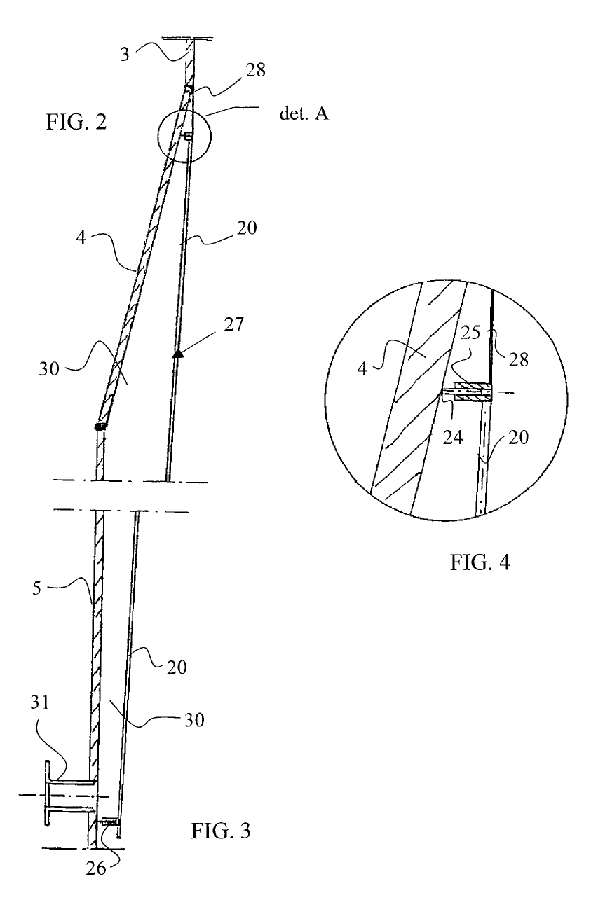

As support rods 24 having an adjustable length are used for supporting the screens 20, the background space 30 between the screen and the inner surface 8 of the pressure vessel according to FIGS. 2 and 3 can be adjusted by changing the length of the support rods. It can thus be arranged that the background space has a volume allowing the flow rate of chips in the digester to increase and preventing deposits from accumulating in the background space and collector tubes 29 in connection with it. The screens can thus be arranged in a slightly conical orientation in respect of the inner surface of the pressure vessel. Hence, the inclination of the cone formed by the screens can be adjusted by changing the length of the support rods.

To secure as flexible an operation as possible for the digester and to minimize service breaks, each screen 20 preferably comprises a separate outlet fitting 31. This outlet fitting is arranged to be in connection with a “header”, i.e. a collector tube outside the digester.

The screens can also be mounted in at least partially overlapping zones, each screen preferably having its own outlet fitting.

It is to be understood that the above description and the related figures are only intended to illustrate the present solution. Thus, the solution is not restricted only to the embodiment described above and defined in the claims, but many different variations and modifications, which are possible within the scope of the idea defined in the attached claims, will be obvious to a person skilled in the art. Thus the bar screen may be used in other continuously operating pressurized and non-pressurised reactors in continuous and batch cooking processes than the digester itself defined above.

1. An arrangement for mounting a screen in a continuous reactor used for making chemical pulp or paper pulp, the reactor comprising a substantially cylindrical vessel arranged in an upright position, the vessel having a smaller diameter at the top end of the reactor than at the bottom end of the reactor, which diameter is arranged to be changed at regionally defined areas by means of one or more conical sections, the screens being mounted in connection with the conical sections to remove a desired quantity of liquid from chips or pulp in the reactor, wherein
an upper edge of the screen, which, in the operating position, is higher in the reactor, is arranged in the region of the conical section and substantially in connection with the section of the conical section which has the smallest diameter,
and a lower edge of the screen, which, in the operating position, is lower in the reactor, is arranged to be orientated towards the bottom end of the reactor
to maximize the screen area of the reactor.

2. An arrangement as claimed in claim 1, wherein the lower edge, which, in the operating position of the screen arranged at the lowermost end of the reactor, is arranged to extend to a round joint combining the lowest, cylindrical cover section and the bottom end forming the bottom of the vessel.

3. An arrangement as claimed in claim 1, wherein the screen is arranged to be supported by an upper transverse support supporting the upper edge of the screen and a lower transverse support supporting the lower edge of the screen, which supports are substantially horizontal and parallel and arranged to be supported against the inner surface of the vessel by means of support rods which combines them.

4. An arrangement as claimed in claim 3, wherein between the upper transverse support and the lower transverse support there is at least one intermediate transverse support, which is parallel with them.

5. An arrangement as claimed in claim 3, wherein the support rods are extendable in the longitudinal direction.

6. An arrangement as claimed in claim 5, wherein the size of a background space of the screen, defined by the screen and the inner surface of the vessel, is adjustable by changing the length of the support rods.

7. An arrangement as claimed in claim 3, wherein the upper transverse support supporting the upper edge of the screen, which, in the operating position, is higher in the reactor, is arranged substantially in connection with a joint combining the conical section and the cover section of the vessel above the conical section.

8. An arrangement as claimed in claim 1, wherein in the vertical direction the reactor is provided with the screens in at least partially overlapping zones.
